(19) United States
(12) Patent Application Publication
(10) Pub. No.: US 2014/0027451 A1
(43) Pub. Date: Jan. 30, 2014

(54) FUEL TANK FUELING DEVICE

(71) Applicants: TOYOTA JIDOSHA KABUSHIKI KAISHA, Toyota-shi (JP); TOYODA GOSEI CO., LTD., Kiyosu-shi (JP)

(72) Inventors: Kenichiro KANEKO, Kiyosu-shi (JP); Toshinori SEKI, Kiyosu-shi (JP); Kunji KITAGAWA, Kiyosu-shi (JP); Shinji SHIMOKAWA, Seto-shi (JP)

(73) Assignees: TOYOTA JIDOSHA KABUSHIKI KAISHA, Toyota-shi (JP); TOYODA GOSEI CO., LTD., Kiyosu-shi (JP)

(21) Appl. No.: 13/948,332

(22) Filed: Jul. 23, 2013

(30) Foreign Application Priority Data
Jul. 24, 2012 (JP) 2012-163296

(51) Int. Cl. B60K 15/01

(52) U.S. Cl. CPC B60K 15/01
USPC 220/86.2

(57) ABSTRACT

A fueling device is equipped with a grating member provided in a fuel path of a fueling pipe, wherein the grating member is equipped with a plurality of ring shaped partition members arranged in concentric circles with the center line of the fuel path as the center, and having differing diameters, and support members for supporting the partition members in relation to the inner wall of the fueling pipe, and wherein the gaps formed between the inner wall of the fueling pipe, the partition members, and the support members are used as a plurality of gap flow paths which are a portion of the fuel path, and the center of each of the partition members is arranged at different positions on the center line.

This application claims the benefit of and priority from Japanese Application No. 2012-168296 filed Jul. 24, 2012, the content of which is incorporated herein by reference.

### BACKGROUND OF THE INVENTION

1. Field of the Invention

The present invention relates to a fueling device for supplying fuel to the fuel tank of a vehicle.

2. Description of the Related Art

An anti-theft mechanism incorporated in the fueling device is disclosed in JP 2010-6246A. The anti-theft mechanism is equipped with a grating member in the fuel path of the inlet pipe to prevent fuel from being stolen through a thin pipe inserted in the inlet pipe from the fuel tank. The anti⁻theft mechanism is required by law in some cases with vehicles that incorporate engines that use fuel with alcohol content of 20% or greater.

### SUMMARY

The grating member noted in the publication described above is equipped with a plurality of annular bodies arranged in concentric circle form in the fuel path of the inlet pipe, and support members for supporting the annular bodies in the inlet pipe. The grating member prevents insertion of a pipe for stealing purposes and also reduces flow path resistance. However, with the grating members, there is a demand for further reduction in flow path resistance.

According to an aspect of the invention, the invention is provided with a fueling device having a fueling pipe for supplying fuel injected through a fueling port to a fuel tank. The fueling device comprises a grating member provided in a fuel path of the fueling pipe. The grating member includes a plurality of ring shaped partition members arranged concentrically with a center line of the fuel path, each partition members having a differing diameter, and support members for supporting the partition members to an inner wall of the fueling pipe. The inner wall of the fueling pipe, the partition members and the support members form a plurality of gap flow paths therebetween, wherein the gap flow paths are a part of the fuel path, and each of the partition members is arranged so that the center of that partition member is at a different position on the center line.

With this mode, the gap flow path of the grating member has a larger opening surface area than the grid arranged on the surface perpendicular to the center line, so large flow volumes flow smoothly.

(2) With the fueling device of the mode noted above, the partition members and the support member are arranged at positions for which it is possible to prescribe a cone curved surface that intersects all of those partition members and the support member.

(3) With the fueling device of the mode noted above, the partition members are formed in a cross section projecting shape for which the cross section area increases from the fueling port side toward the fuel tank side, and the outer surface of the partition members are formed so as to match the curved surface of the cone. With this constitution, it is possible to make the flow volume that passes through the plurality of gap flow paths of the grating member even, and it is possible to have smooth fueling without the flow focusing particularly near the center line.

(4) With the fueling device of the mode noted above, the plurality of gap flow paths can be formed as arc shapes of a designated width from the outer circumference side to the inner circumference side, and with the partition members, when the plurality of gap flow paths are projected on a surface perpendicular to the center line, the flow path area of the outer circumference side gap flow paths can be formed so as to be greater than the flow path area of the inner circumference side gap flow paths.

(5) With the fueling device of the mode noted above, at least one of the partition members has an inner circumference wall which is parallel to the center line.

(6) With the fueling device of the mode noted above, at least one of the partition members includes: an inner circumference wall arranged in parallel to the center line, an outer surface arranged on the fueling port side and tilted in relation to the center line, and a bottom surface arranged on the fuel tank and formed so as to define an obtuse angle in relation to the outer surface from an outside edge of the outer surface.

(7) With the fueling device of the mode noted above, at least one of the partition members has an inner circumference wall arranged in parallel to the center line, and an outer surface formed as a curved surface to connect an upper edge of the inner circumference wall to an lower edge of the inner circumference wall, the curved surface being directed toward the center line side after curving to the outer circumference side.

(8) With the fueling device of the mode noted above, the partition member arranged furthest to the outer circumference side of the fuel path is arranged so as to constitute a gap flow path with an inner wall of the fueling pipe.

These and other objects, features, aspects, and advantages of the present invention will become more apparent from the following detailed description of the preferred embodiments with the accompanying drawings.

### BRIEF DESCRIPTION OF THE DRAWINGS

FIG. 1 is a schematic drawing showing a fueling device for supplying fuel to the fuel tank of an automobile.

FIG. 2 is a cross section view enlarged near the fuel tank connector, the path forming member and the check valve.

FIG. 3 is a plan view seen from the arrow 3 direction in FIG. 2.

FIG. 4 is a cross section view along line 4-4 in FIG. 3.

FIG. 5 is a cross section view along line 5-5 in FIG. 3.

FIG. 6 is a perspective view showing a partial cutaway of the fuel tank connector.

FIG. 7 is a perspective view showing the grating member.

FIG. 8 shows the shape of the grating member.

FIG. 9 shows a valve plate.

FIG. 10 shows the fueling operation of the fueling device.

FIG. 11 shows the operation of the grating member.

FIG. 12 shows the operation of the grating member.

FIG. 13 shows the operation of the grating member.

FIG. 14 is a half section view showing the fuel tank connector of the second embodiment.

FIG. 15 is a cross section view showing the fuel tank connector of the third embodiment.

FIG. 16 is a cross section view showing the fuel tank connector of the fourth embodiment.

FIG. 17 is a cross section view showing the fuel tank connector of the fifth embodiment.

### DESCRIPTION OF THE PREFERRED EMBODIMENTS

(1) Schematic Structure of the Fueling Device FS

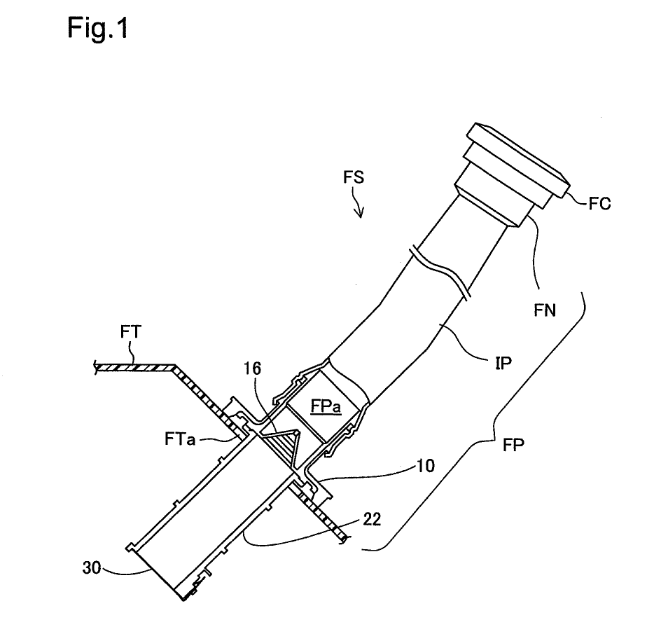

FIG. 1 is a schematic drawing showing a fueling device FS for supplying fuel to the fuel tank FT of an automobile of the first embodiment of the present invention. As shown in FIG. 1, the fueling device FS is connected to the fuel tank FT and sends fuel supplied from a fueling gun (not illustrated) to the fuel tank FT. The fueling device FS is equipped with a fueling pipe FP that forms a fuel path FPa from a fueling port to the fuel tank FT. The fueling pipe FP is equipped with a filler neck FN having the fueling port that is opened and closed by a fuel cap FC, a resin inlet pipe IP connected to one end of the filler neck FN, a fuel tank connector 10 connected to one end of the inlet pipe IP and welded to the fuel tank FT, and a path forming member 22 welded to the fuel tank connector 10. A check valve 30 is mounted on the tip of the path forming member 22. A breather pipe (not illustrated) is connected to the filler neck FN. The breather pipe is connected to the filler neck FN and the fuel tank FT. With the constitution of the fueling device FS, when the fuel cap FC is removed during fueling and fuel is injected from the fueling gun to the filler neck FN, fuel flows through the inlet pipe IP, the fuel tank connector 10, and the fuel path FPa within the path forming member 22, and furthermore, the check valve 30 opens and it is supplied into the fuel tank FT. Meanwhile, when fueling stops, the check valve 30 is in a closed valve state, so even if fuel is pushed and returned to the inlet pipe IP side by the risen internal pressure of the tank, outflow to the outside is prevented.

### (2) Constitution and Operation of Each Part

The following describes the constitution of each part.

(2)-1 Fuel Tank FT

The fuel tank FT is made of a barrier layer formed from an ethylene vinyl alcohol copolymer (EVOH) which has excellent fuel permeability resistance, and from a plurality of resin layers including an outer layer formed by polyethylene (PE) laminated on the barrier layer. A tank opening FTa is formed in the top part of the side wall of the fuel tank FT. The fuel tank connector 10 is welded so as to enclose the tank opening FTa.

(2)-2 Fuel Tank Pipe Connecting Unit 10

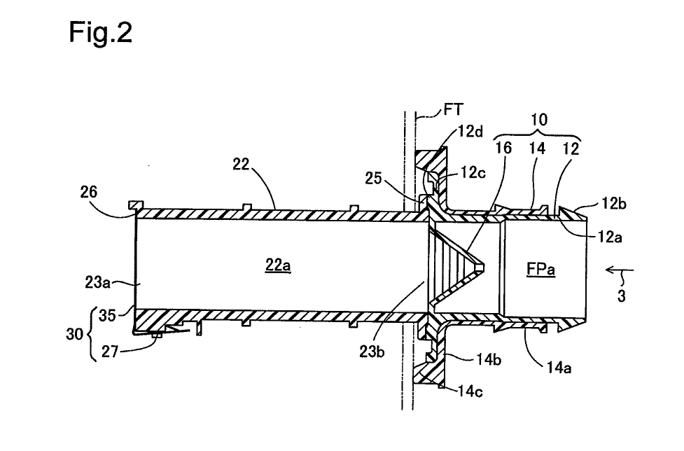

FIG. 2 is a cross section view enlarged the fuel tank connector 10, the path forming member 22, and the check valve 30. The fuel tank connector 10 is equipped with a path forming unit 12, a connecting weld part 14, and a grating member 16, and these are formed as an integrated unit using two color molding. The path forming unit 12 is equipped with a path unit 12a which forms the path connecting to the inlet pipe IP. One end of the path unit 12a becomes a retention expansion part 12b for retaining the inlet pipe IP by expanding from the outer circumference end of that path part 12a. A flange 12c is formed at the other end of the path part 12a. One surface of the flange 12c becomes the surface welded to the inner wall of the connecting weld part 14. The other surface of the flange 12c becomes a welding part 12d for welding one end of the path forming member 22. The path forming unit 12 is made of a polyamide (PA) such as nylon-12 or the like, for example.

The connecting weld part 14 is equipped with an outer tube part 14a, a flange 14b which is expanded from one end outer circumference of the outer tube part 14a, and a weld end 14c provided projecting in a ring form at one end surface of the flange 14b. The connecting weld part 14 is made of denatured polyethylene which can be thermally welded to the fuel tank FT. The denatured polyethylene is a resin material for which a polar functional group, for example a maleic acid denatured functional group, is added to polyethylene (PE), and is a material that undergoes reactive adhesion with the polyamide (PA) by the heat during injection molding. Thus, the connecting weld part 14 is welded as an integrated unit by reactive adhesion with the path forming unit 12 using two color molding.

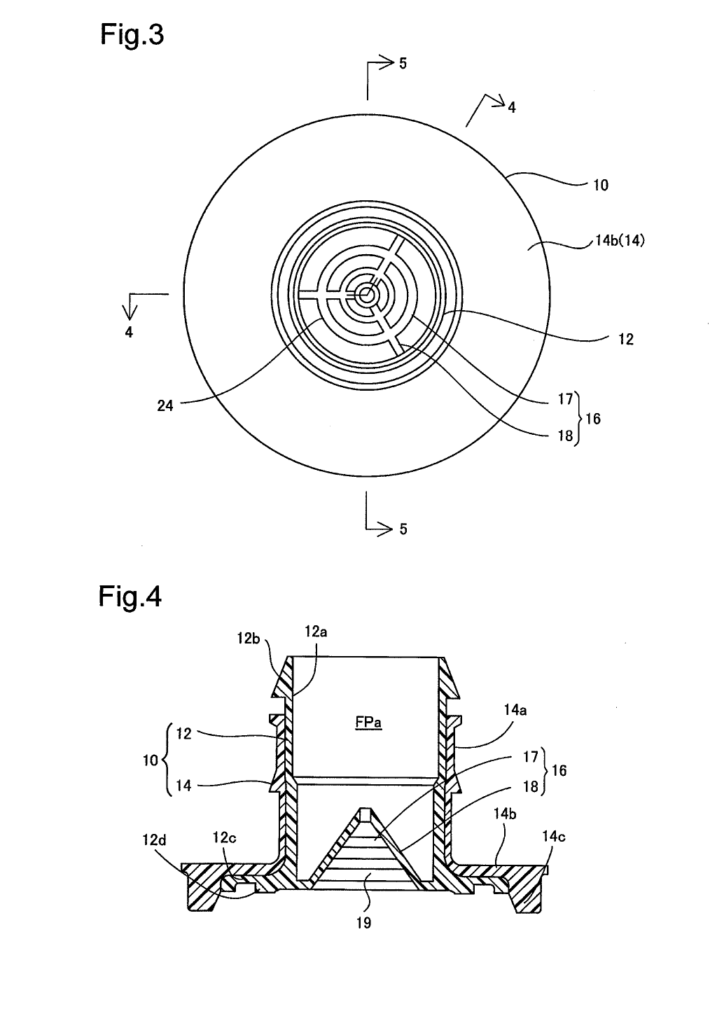

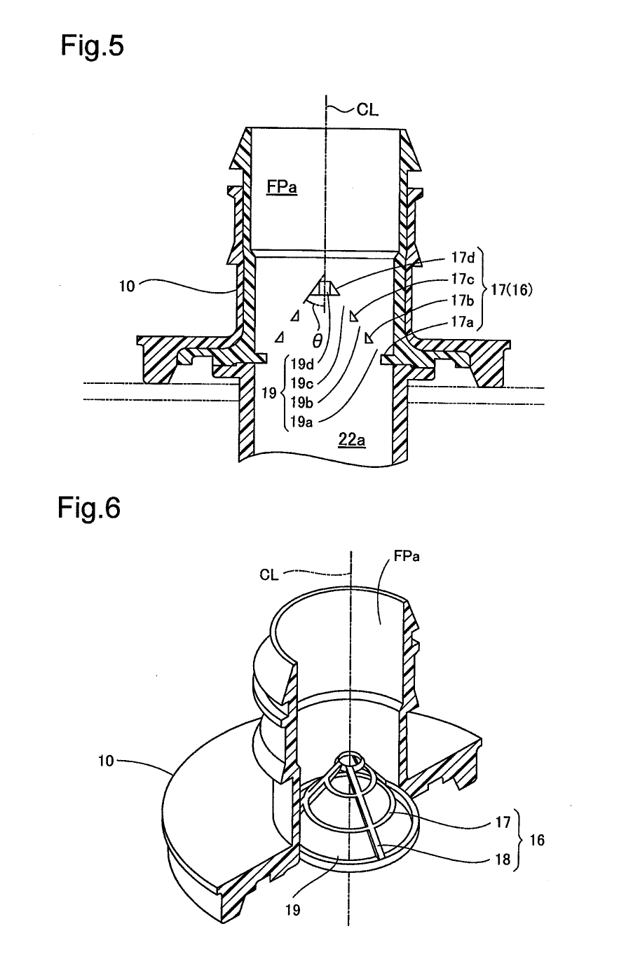

FIG. 3 is a plan view seen from the arrow 3 direction of the path forming member 22. FIG. 4 is a cross section view along line 4-4 in FIG. 3. FIG. 5 is a cross section view along line 5-5 in FIG. 3. FIG. 6 is a perspective view showing a partial cutaway of the fuel tank connector 10. The grating member 16 is arranged in a state extended across the fuel path FPa on the end part of the outlet side of the fuel tank connector 10. The grating member 16 is equipped with partition members 17 and support members 18, and is formed using resin as an integral unit with the fuel tank connector 10.

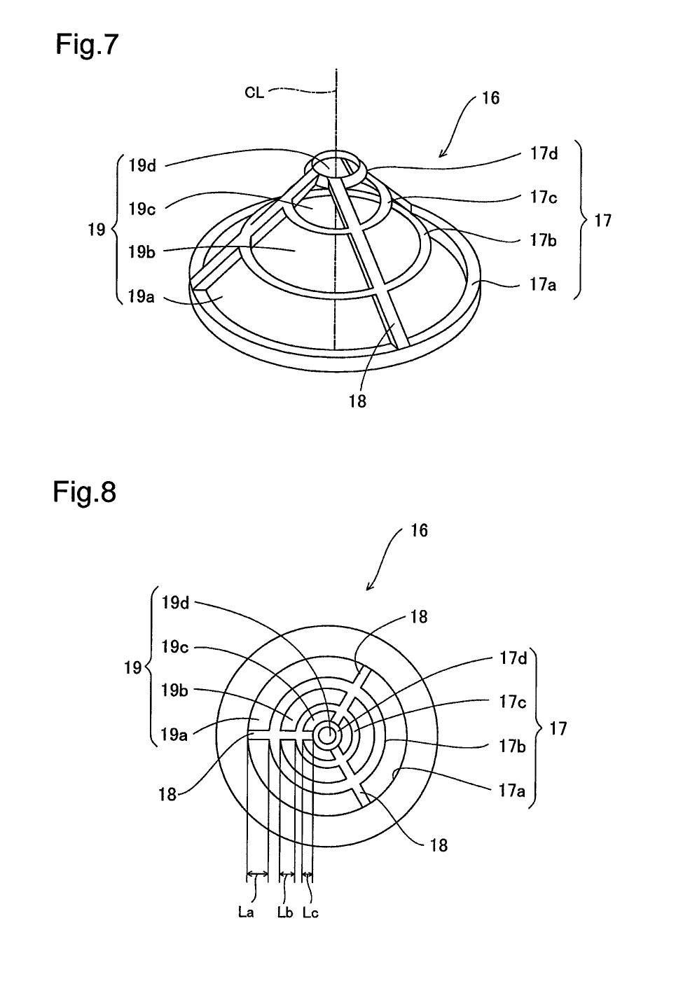

FIG. 7 is a perspective view for describing the grating member 16. The grating member 16 is equipped with a plurality of ring shaped partition members 17. The partition members 17 are equipped with first through fourth partition members 17a, 17b, 17c, and 17d arranged facing the center line CL from the outer circumference side of the fuel path FPa. The first through fourth partition members 17a to 17d have respectively different diameters with the center line CL as the center, and in fact are respectively arranged at different positions facing the fueling port side (top side in the drawing) from the outlet side (bottom side in the drawing) of the fuel tank connector 10. Also, as shown in FIG. 5, the respective cross sections of the second through fourth partition members 17b to 17d are projecting shapes with a cross section for which the cross section area increases directing from the fueling port side to the fuel tank side. An example of a projecting shape is a cross section that is a right angle triangle. The hypotenuse of the right angle triangle is arranged facing the fuel path of the fueling side. The center line CL is shown as a line along the center of the fuel path FPa, but the invention is not limited to this, and it is also possible to include positions slightly biased from the cross section circle of the fuel path.

In FIG. 7, three support members 18 are erected diagonally upward with a gap of 120° in the circumference direction from the ring shaped first partition member 17a. The support members 18 join the first partition member 17a and the fourth partition member 17d with a 120° in the circumference direction, and the partition members 17 are supported by intersecting that midway with the first and second partition members 17b and 17c to make an integral unit. The three support members 18 are arranged on the cone surface, and as shown in FIG. 5, this is set to vertex angle θ in relation to the center line CL.

In FIG. 8, the gap formed between the inner wall of the fueling pipe FP, the partition members 17, and the support members 18 become a plurality of gap flow paths 19 which are a part of the fuel path. The gap flow paths 19 are constituted by first through fourth gap flow paths 19a to 19d. The first through fourth partition members 17a, 17b, 17c, and 17d have respectively different outer diameters, so the first through third gap flow paths 19a to 19c have an arc shape of a designated width, and have a tilted opening that tilts along the cone surface. Also, the fourth gap flow path 19d is a circular flow path. Also, as shown in FIG. 8, the first through fourth gap flow paths 19a to 19d are set to a width for which it is not possible to insert a pipe for stealing of a designated diameter or greater. For example, when preventing insertion of a pipe for stealing of diameter 5.2 mm or greater, the gap flow paths 19 are respectively set to 5.2 m or less. Also, when viewed by the surface (plan view) projecting in a perpendicular direction to the center line, the first through third flow paths 19a to 19c become narrower facing from the gap flow path of the outer circumference side toward the gap flow path of the inner circumference side; in other words, La>Lb>Lc.

(2)-3 Constitution of the Path Forming Member 22 and the Check Valve 30

In FIG. 2, the path forming member 22 is a tube shape formed from the same polyamide (PA) as the path forming unit 12, and on its interior there is a path 22a connected to the inlet pipe IP. The inlet pipe IP side of the path forming member 22 becomes an inlet 23b. A flange 25 is formed on the end part of the inlet 23b of the path forming member 22. The flange 25 becomes an integrated unit by welding with the welding part 12d of the path forming unit 12 and forms a flow path.

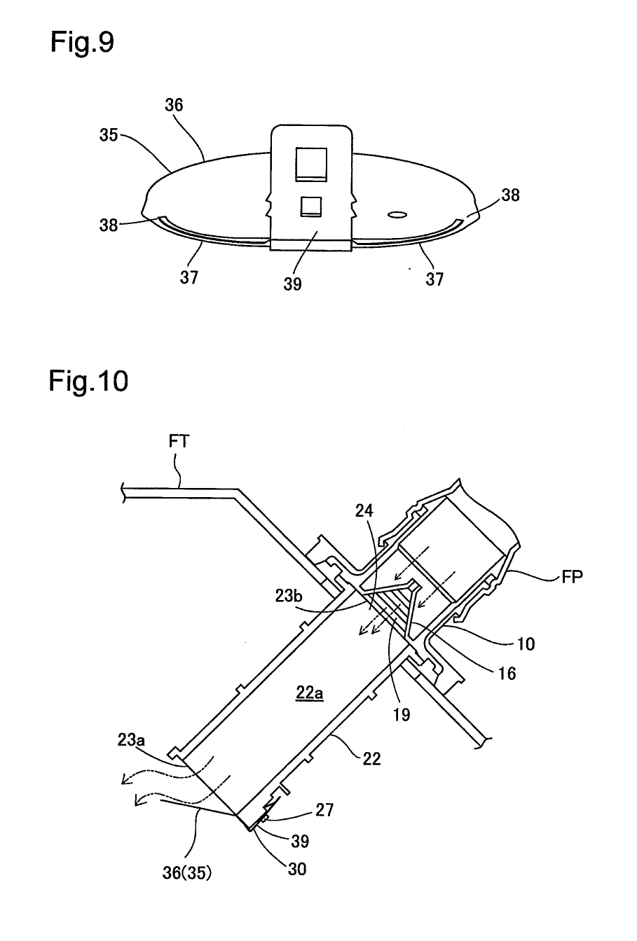

The check valve 30 is equipped with an attachment unit 27 formed on the outer circumference end part of the path forming member 22, and a valve plate 35 attached to the attachment unit 27 that opens and closes the outlet 23a. FIG. 9 shows the valve plate 35. The valve plate 35 is formed as a plate spring as an integrated unit with the almost round disk shaped closing unit 36, the arm units 37, 37, the linking units 38, 38, and the part for attachment 39. The closing unit 36 has almost the same shape as the external shape of the sheet unit 26 (FIG. 2), and is an item that opens and closes the outlet 23a. The closing unit 36 is formed so as to attach and detach with the sheet unit 26. The arm units 37, 37 are formed so as to enclose the almost semicircle of the outer circumference part of the closing unit 36. Each of the end parts of the arm units 37, 37 are respectively linked to the closing part 36 via the linking units 38, 38.

The part for attachment 39 is a part supported to be able to open and close the closing part 36 by being inserted in the attachment unit 27 shown in FIG. 2, and is bent in relation to the closing part 36.

As shown in FIG. 10, with the check valve 30 of this constitution, during fueling, when the fuel that flows in the fuel tank connector 10 from the fueling pipe FP flows through the path 22a and reaches the outlet 23 after passing through the gap flow paths of the grating member 16 arranged at the inlet 23b, it presses the closing unit 36 of the valve plate 35. The valve plate 35, after being attached to the attachment unit 27 by the part for attachment 39, opens with the part for attachment 39 as a fulcrum, and the outlet 23a opens and fuel flows out.

### (3) Operation and Effect of the Embodiment

The following effects are exhibited with the constitution of the embodiment noted above.

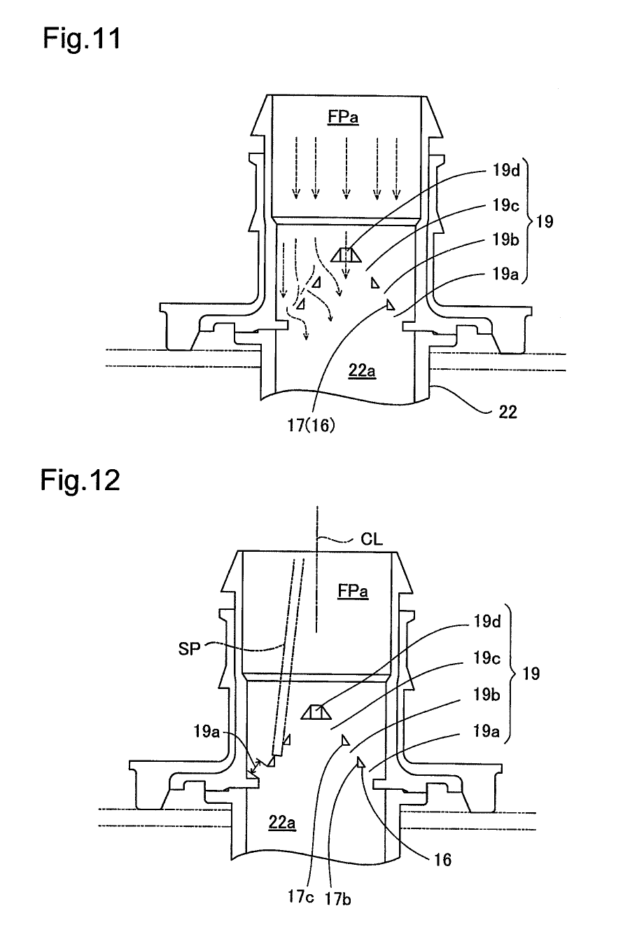

(3)-1 In FIG. 1 and FIG. 2, the fuel supplied from the fueling port to the fuel path FPa of the inlet pipe IP flows through the gap flow paths 19 of the grating member 16 shown in FIG. 5 to the path 22a of the fuel tank side. At this time, the flow of fuel that passes through the gap flow paths 19 is analyzed as follows. The fueling pipe FP is routed to be tilted in relation to the horizontal direction, so the fuel that flows at the start of fueling flows along the pipe wall at the bottom side of the inlet pipe IP, and then mainly through the gap flow paths 19 of the bottom side of the outer circumference of the grating member 16 to the fuel tank side. As shown in FIG. 11, the first through third gap flow paths 19a to 19c of the gap flow path 19 are tilted openings having an opening surface area greater than the surface area projected to the surface perpendicular from the center line, and in fact the first gap flow path 19a of the outer circumference side has a flow path area greater than that of the second and third gap flow paths 19b and 19c of the inner circumference side (see FIG. 8), so the initial large flow volume flows smoothly along the inner wall of the bottom side of the inlet pipe IP. Thus, the disturbance of the initial flow along the inner pipe wall of the inlet pipe IP is kept to a minimum. Then, when the fuel increases to a constant volume and flows across almost the entire area of the fuel path FPa, the flow speed is high, so fuel passes through quickly, remaining at a streamline flow without the flow being disturbed at the grating member 16. Therefore, the grating member 16 does not cause turbulence due to the fuel of the fueling start that flows along the inner wall of the inlet pipe IP. Since turbulence does not occur, hindrance of the fueling task is not caused because there is no increase in flow path resistance of the fuel that flows after the end of the initial fueling.

(3)-2 As shown in FIG. 12, the grating member 16 partitions a portion of the fuel path using the second and third partition members 17b and 17c. As shown in FIG. 8, the first through fourth gap flow paths 19a to 19d have the gap that become narrower than the outer diameter of a pipe for stealing when projected to the surface in a direction perpendicular to the center line CL. Thus, as shown in FIG. 12, even if the pipe for stealing SP is inserted in the fuel path FPa from the fueling port, the pipe for stealing SP stays as is in a straight line shape, and is not inserted from the grating member 16 to the tank side path 22a. Also, even if the gap of the tilted opening of the gap fuel path 19 is greater than the diameter of the pipe for stealing, when inserted from the tilted opening, flexible pipes are bent by the partition members 17, and cannot be inserted further into the fuel tank. Thus, the tip of the pipe for stealing SP does not reach the fuel liquid surface within the fuel tank, so it is not possible to suck out fuel from the fuel tank through the pipe for stealing SP, and it is possible to prevent stealing of fuel.

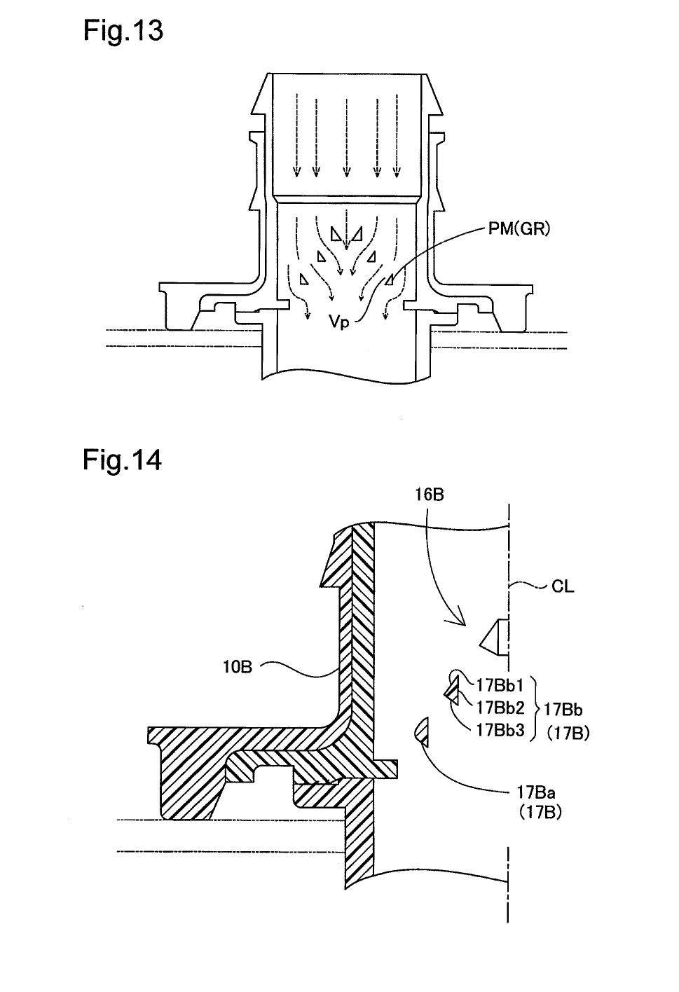

(3)-3 As shown in FIG. 11, since the partition members 17 have a cross section for which the fueling port side is the vertex angle formed in a right angle triangle shape, the partition members 17 does not increase flow path resistance of the fuel. In fact, the partition members 17 have the outer surface tilted from the center to the outer circumference side as the tilted surface and are formed with the cross section as a right angle triangle, so a large portion of the fuel that contacts the tilted surface flows along the tilted surface, and the remainder enters the flow path on the inside of the grating member 16. Thus, as shown with grating member GR in FIG. 13, with a shape with the cross section as an equilateral triangle for which the surface facing from the outer circumference side of the partition member PM toward the center is a tilted surface, the fuel goes through the gap fuel path Vp and concentrates at the center portion. However, with the grating member 16 of the embodiment, it is difficult for the fuel to concentrate at the center portion. Thus, the grating member 16 of the embodiment in FIG. 12 does not go to a state for which the fuel is clogged in the fuel path, streamline flow is maintained, and the flow path resistance is decreased.

With the fuel tank system, the fueling device FS, to make supplying of fuel at fueling start smooth as it passes through the fuel tank and the canister, and to the outside air, the specification is that the overall ventilation resistance is a designated pressure drop value or less. With this embodiment, the pressure drop value allowed on the canister side can be made greater by the amount that it is possible to make the flow path resistance smaller with the grating member 16. Thus, the canister can use a structure for which the pressure drop is great, but it is possible to reduce the discharging of fuel vapor to the atmosphere.

(3)-4 In FIG. 5, the grating member 16 has a vertex angle θ in relation to the center line CL. When the relationship between the vertex angle θ and the flow path resistance is studied, when the vertex angle θ is smaller than 45°, we found that the flow path resistance becomes smaller. However, when the vertex angle θ of the grating member 16 is smaller than 20°, the surface area of the tilted opening becomes larger. The flexible pipe for stealing SP enters more easily at a diagonal angle between the partition members 17, reducing the fuel theft prevention effect. Thus, the vertex angle θ is preferably 20° or greater.

(3)-5 The grating member 16 does not make the fuel path resistance of the fuel greater, so it is possible to apply this not only to alcohol type fuel tanks but also to fuel tanks for gasoline with the same fueling pipe FP pipe diameter as with the prior art, so its versatility is high.

### (4) Other Embodiments

This invention is not limited to the embodiment noted above, and can be implemented in various modes in a scope that does not stray from its gist, with the following kinds of modifications being possible, for example.

(4)-1 FIG. 14 is a half section view showing the fuel tank connector 10B of the second embodiment. This embodiment has its characteristic feature in the cross section shape of the partition members 17B of the grating member 16B of the fuel tank connector 10B. The second partition member 17Bb is constituted by an outer surface 17Bb1, an inner circumference wall 17Bb2, and a bottom surface 17Bb3, and is a cross section triangle shape which is one example of the cross section projecting shape. The inner circumference wall 17Bb2 is arranged in parallel with the center line CL. The outer surface 17Bb1 faces toward the bottom edge of the inner circumference wall 17Bb2 from the top edge of the inner circumference wall 17Bb2, and is formed so as to face the center line CL side after curving to the outer circumference side.

With the shape of the second partition member 17Bb, the inner circumference wall 17Bb2 is formed in parallel with the center line CL, so it is possible for fuel to flow smoothly through the inner circumference side of the partition member 17B. In fact, the bottom surface 17Bb3 projects to the tank side in the vertical direction in relation to the center line CL, so the angle between the outer surface 17Bb1 and the bottom surface 17Bb3 is an obtuse angle, and the detachment of the fluid body in relation to the second partition member 17Bb is lower. Thus, it is possible to reduce flow path resistance when flowing in the grating member 16B. It is also possible to reduce the flow path resistance by using a shape for which the outer surface is curved as shown with the first partition member 17Ba as the cross section shape of the partition member 17B.

With the embodiment noted above, the cross section shape of the partition member is a cross section triangle, but this can also be a cross section polygon shape in a range that does not stray from the gist of the present invention.

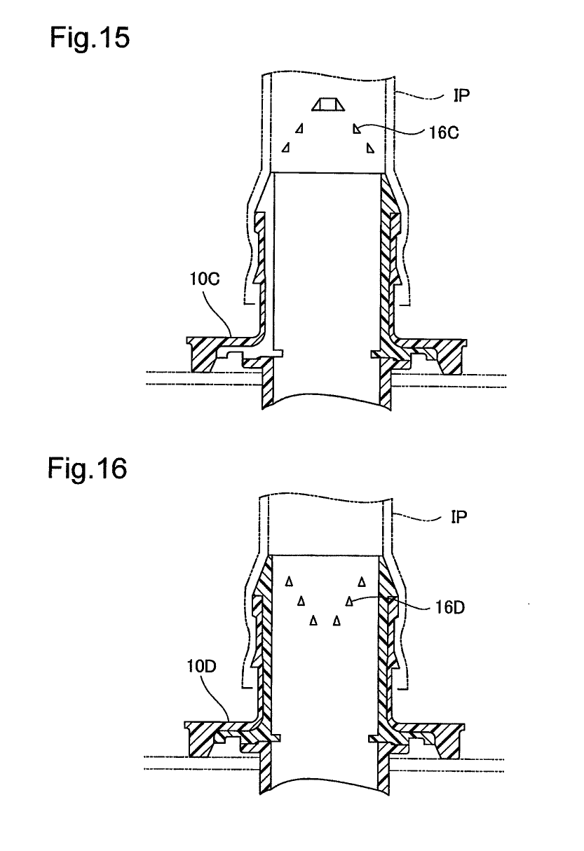

FIG. 15 is a cross section view showing the fuel tank connector 10C of the third embodiment. This embodiment has its characteristic feature in the attachment position of the grating member 16C. Specifically, the grating member 16C is arranged at the inlet side of the fuel tank connector 10C. With the first embodiment described above, of the fueling pipe, the grating member is provided at a position near the fuel tank wall surface, but as with this embodiment, the same effects are exhibited even if provided at the fuel tank connector 10C near the connecting location with the inlet pipe IP side.

FIG. 16 is a cross section view showing the fuel tank connector 10D of the fourth embodiment. With this embodiment, the vertex of the triangular cone of the grating member 16D is arranged at the fuel tank side. In this way, it is possible for the arrangement of the partition members of the grating member to use various arrangements taking into consideration the flow path resistance and the manufacturing process.

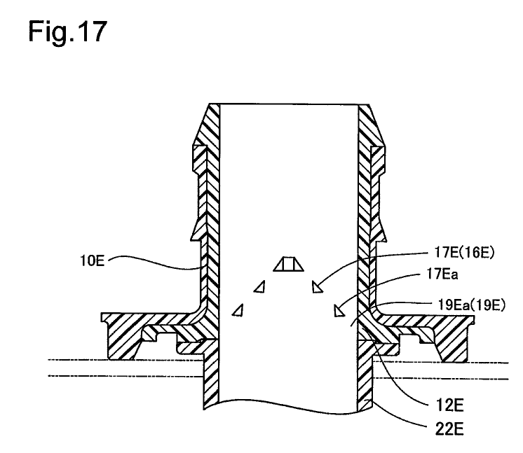

FIG. 17 is a cross section view showing the fuel tank connector 10E of the fifth embodiment. With this embodiment, the characteristic feature is in the shape of the partition member 17E. The partition member 17E has a first partition member 17Ea which is the outermost circumference side of the fuel path and is arranged at the inner circumference side of the path forming unit 12E. The first partition member 17Ea is arranged at a position separated from the inner wall of the path forming unit 12E, and forms the space in relation to the inner wall as the first gap flow path 19Ea. With this constitution, the inner wall of the path forming unit 12E is flush with the inner wall of the path forming member 22E, so it is possible to reduce flow path resistance for fuel flowing along the inner wall of the path forming unit 12E.

Also, with this embodiment, the grating member 16 is formed as an integrated unit with the fuel tank connector 10, but the invention is not limited to this, and in addition to forming it as an integrated unit with the path forming member 22, the inlet pipe IP or the like, it is also possible to have a constitution attached to another member.

The present invention is not limited to the modes and embodiments described above, and it is possible to realize it with various constitutions that do not stray from its gist. For example, in order to address a part or all of the problems described above, or to achieve a portion or all of the effects described above, the technical characteristics in the modes, embodiments, and modification examples correlating to the technical characteristics in each mode noted in the abstract section of the invention can be interchanged or combined as appropriate. Also, if that technical characteristic is not explained as an essential item in the specification, it can be eliminated as appropriate.

What is claimed is:

1. A fueling device having a fueling pipe for supplying fuel injected through a fueling port to a fuel tank, the fueling device comprising a grating member provided in a fuel path of the fueling pipe, wherein
the grating member includes: (i) a plurality of ring shaped partition members arranged concentrically with a center line of the fuel path, each partition members having a differing diameter; and (ii) support members for supporting the partition members to an inner wall of the fueling pipe,
wherein the inner wall of the fueling pipe, the partition members and the support members form a plurality of gap flow paths therebetween, wherein the gap flow paths are a part of the fuel path, and
each of the partition members is arranged so that the center of that partition member is at a different position on the center line.

2. The fueling device according to claim 1 wherein
the partition members and the support members are arranged at positions on a cone curved surface, wherein the cone curved surface is a surface on which all of the partition members and the support members intersect.

3. The fueling device according to claim 2 wherein
the partition members are formed such that the cross section area of the partition members increase from the fueling port toward the fuel tank, and outer surfaces of the partition members match the cone curved surface.

4. The fueling device according to claim 3 wherein
the plurality of gap flow paths are formed as a plurality of arc shapes of a designated width arranged in concentric circles, and
the partition members are configured such that the flow path area of the gap flow paths arranged at the outer circumference side are greater than the flow path area of the gap flow paths arranged at the inner circumference side when the plurality of gap flow paths are projected on a surface perpendicular to the center line.

5. The fueling device according to claim 3 wherein
at least one of the partition members has an inner circumference wall which is parallel to the center line.

6. The fueling device according to claim 3 wherein
at least one of the partition members includes:
an inner circumference wall arranged in parallel to the center line,
an outer surface arranged on the fueling port side and tilted in relation to the center line, and
a bottom surface arranged on the fuel tank and formed so as to define an obtuse angle in relation to the outer surface from an outside edge of the outer surface.

7. The fueling device according to claim 3 wherein
at least one of the partition members has
an inner circumference wall arranged in parallel to the center line, and an outer surface formed as a curved surface to connect an upper edge of the inner circumference wall to an lower edge of the inner circumference wall, the curved surface being directed toward the center line side after curving to the outer circumference side.

8. The fueling device according to claim 1 wherein
the plurality of gap flow paths are formed as a plurality of arc shapes of a designated width arranged in concentric circles, and
the partition members are configured such that the flow path area of the gap flow paths arranged at the outer circumference side are greater than the flow path area of the gap flow paths arranged at the inner circumference side when the plurality of gap flow paths are projected on a surface perpendicular to the center line.

9. The fueling device according to claim 1 wherein
the partition member arranged furthest to the outer circumference side of the fuel path is arranged so as to constitute a gap flow path with an inner wall of the fueling pipe.
